(19) United States
(12) Patent Application Publication
(10) Pub. No.: US 2013/0098674 A1
(43) Pub. Date: Apr. 25, 2013

(54) ADHESIVE BACKED CABLING SYSTEM FOR IN-BUILDING WIRELESS APPLICATIONS

(71) Applicants: Curtis L. Shoemaker, Round Rock, TX (US); Stephen C. King, Lakeway, TX (US); Kurt H. Petersen, Austin, TX (US); Stephen Paul LeBlanc, Austin, TX (US)

(72) Inventors: Curtis L. Shoemaker, Round Rock, TX (US); Stephen C. King, Lakeway, TX (US); Kurt H. Petersen, Austin, TX (US); Stephen Paul LeBlanc, Austin, TX (US)

(73) Assignee: 3M INNOVATIVE PROPERTIES COMPANY, ST. PAUL, MN (US)

(21) Appl. No.: 13/805,158

(22) PCT Filed: Jun. 1, 2011
(86) PCT No.: PCT/US11/38663

§ 371 Date: Dec. 18, 2012

Related U.S. Application Data
(60) Provisional application No. 61/357,783, filed on Jun. 23, 2010.
(60) Provisional application No. 61/483,234, filed on May 6, 2011.

(51) Int. Cl. H01B 7/40

(52) U.S. Cl. CPC H01B 7/40
USPC 174/480

(57) ABSTRACT

An adhesive-backed multi-channel RF signal cable comprises a main body having at least one conduit portion with a bore formed throughout and containing one or more RF signal channels, and a flange portion having an adhesive backing layer to mount the cable to a mounting surface. The adhesive-backed cabling provides for multiple channels of RF/cellular traffic to be distributed, where these channels can be dedicated to different carriers, each needing wireless distribution in a building, different services, and/or routing signals to different locations within a building.

### BACKGROUND OF THE INVENTION

1. Field of the Invention

The present invention is directed to adhesive-backed cabling for in-building wireless (IBW) horizontal cabling applications.

2. Background

The continuing expansion of wireless communication and its accompanying wireless technology will require many more “cell sites” than are currently deployed. This expansion has been estimated from a doubling to a ten-fold increase in the current number of cell sites, particularly in the deployment of 4G/LTE (long term evolution) networks. This dramatic increase in the number of cell sites is due, at least in part, to the high bandwidth demand for wireless applications, where the bandwidth of a given cell site must be shared with all available UE (user equipment) within range of the site.

Better wireless communication coverage is needed to provide the desired bandwidth to an increasing number of customers. Thus, in addition to new deployments of traditional, large “macro” cell sites, there is a need to expand the number of “micro” cell sites (sites within structures, such as office buildings, schools, hospitals, and residential units). In-Building Wireless (IBW) Distributed Antenna Systems (DASs) are utilized to improve wireless coverage within buildings and related structures. Conventional DASs use strategically placed antennas or leaky coaxial cable (leaky coax) throughout a building to accommodate radio frequency (RF) signals in the 300 MHz to 6 GHz frequency range. Conventional RF technologies include TDMA, CDMA, WCDMA, GSM, UMTS, PCS/cellular, iDEN, WiFi, and many others.

Outside the United States, carriers are required by law in some countries to extend wireless coverage inside buildings. In the United States, bandwidth demands and safety concerns will drive IBW applications, particularly as the world moves to current 4G architectures and beyond.

There are a number of known network architectures for distributing wireless communications inside a building. These architectures include choices of passive, active and hybrid systems. Active architectures generally include manipulated RF signals carried over fiber optic cables to remote electronic devices which reconstitute the electrical signal and transmit/receive the signal. Passive architectures include components to radiate and receive signals, usually through a punctured shield leaky coax network. Hybrid architectures include native RF signal carried optically to active signal distribution points which then feed multiple coaxial cables terminating in multiple transmit/receive antennas. Specific examples include analog/amplified RF, RoF (Radio over Fiber, also known as RFoG, or RF over glass), fiber backhaul to pico and femto cells, and RoF vertical or riser distribution with an extensive passive coaxial distribution from a remote unit to the rest of the horizontal cabling (within a floor, for example). These conventional architectures can have limitations in terms of electronic complexity and expense, inability to easily add services, inability to support all combinations of services, distance limitations, or cumbersome installation requirements.

Conventional cabling for IBW applications includes RADIAFLEX™ cabling available from RFS (www.rfsworld.com), standard ½ inch coax for horizontal cabling, ⅞ inch coax for riser cabling, as well as, standard optical fiber cabling for riser and horizontal distribution.

Physical and aesthetic challenges exist in providing IBW cabling for different wireless network architectures, especially in older buildings and structures. These challenges include gaining building access, limited distribution space in riser closets, and space for cable routing and management.

### SUMMARY

According to an exemplary aspect of the present invention, an adhesive-backed multi-channel RF signal cable comprises a main body having at least one conduit portion with a bore formed throughout and containing one or more RF signal channels, and a flange portion having an adhesive backing layer to mount the cable to a mounting surface.

In one aspect, the main body and flange portion are formed from a polymer. In a further aspect, the polymer is a polymer that is extruded over the one or more RF signal channels. In another aspect, the main body and flange portion are formed from a metal. In a further aspect, the metal is covered by a layer of low dielectric material having a thickness of 2 mils or less.

In another aspect, the main body includes two conduit portions, wherein a first conduit includes a first RF signal channel and a second conduit includes a second RF signal channel. In a further aspect, the first RF signal channel comprises a coax cable and the second RF signal channel comprises an optical fiber. In a further aspect, the coax cable is configured to radiatively send and/or receive a first RF signal from the first channel. In a further aspect, the radial position of the first RF signal channel is maintained throughout the length of the RF signal cable. In a further aspect, the first channel comprises a plurality of radiating apertures formed longitudinally along the axial length of the first channel. In a further aspect, the first channel includes a longitudinal slot formed along the axial length of the first channel, wherein the longitudinal slot has an opening from about 20 degrees to about 55 degrees. In a further aspect, the second conduit includes multiple optical fibers each providing its own separate RF signal channel.

According to another aspect of the present invention, a distributed antenna system for in-building wireless applications comprises an adhesive-backed multi-channel RF signal cable that includes a main body having at least one conduit portion with a bore formed throughout and containing one or more RF signal channels and a flange portion having an adhesive backing layer to mount the cable to a mounting surface.

In another aspect, the adhesive-backed multi-channel RF signal cable includes a first RF signal channel carrying an RF signal from a first wireless service provider and a second RF signal channel carrying an RF signal from a second wireless service provider. In another aspect, the adhesive-backed multi-channel RF signal cable is adhesively mountable to a building wall at a position just below a ceiling.

In another aspect, the adhesive-backed multi-channel RF signal cable provides horizontal cabling for a hybrid network architecture. In another aspect, the adhesive-backed multi-channel RF signal cable provides horizontal cabling for a passive network architecture. In another aspect, the adhesive-backed multi-channel RF signal cable provides horizontal cabling for an active network architecture.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1A is an isometric view of a first exemplary adhesive-backed duct in accordance with an aspect of the present invention.

FIG. 1B is an isometric view of another exemplary adhesive-backed duct in accordance with another aspect of the present invention.

FIG. 1C is an isometric view of another exemplary adhesive-backed duct in accordance with another aspect of the present invention.

FIGS. 2A-2D are isometric section views of alternative adhesive-backed multi-channel cables according to other aspects of the present invention.

FIGS. 3A-3C are cross section views of alternative adhesive-backed multi-channel cables according to other aspects of the present invention.

FIG. 4 is an isometric section view of an exemplary adhesive-backed laminated multi-channel cable according to another aspect of the present invention.

FIG. 5A is a schematic view of an exemplary adhesive-backed duct mounted on a wall in accordance with another aspect of the invention.

FIG. 5B is a schematic view of an exemplary adhesive-backed duct mounted on a wall in accordance with another aspect of the invention.

FIG. 5C is a schematic view of an exemplary adhesive-backed duct mounted on a wall in accordance with another aspect of the invention.

FIG. 5D is a schematic view of an exemplary adhesive-backed duct mounted on a wall in accordance with another aspect of the invention.

FIG. 6A is an isometric view of another exemplary adhesive-backed duct in accordance with another aspect of the present invention.

FIG. 6B is an isometric view of another exemplary adhesive-backed duct in accordance with another aspect of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to polymeric or laminated metallic cabling for horizontal cabling for in-building wireless (IBW) applications. The inventive cabling solutions described herein provide radio frequency (RF) signal pathways for coaxial (coax) cables, optical fiber, and power distribution cabling. The adhesive-backed cabling is designed with a low impact profile for better aesthetics. The adhesive-backed cabling provides for multiple channels of RF/cellular traffic to be distributed. These multiple channels can be dedicated to different carriers, with each carrier needing wireless distribution in a building or to providing different services. These multiple channels can also be dedicated to routing signals to different locations within a building. The adhesive-backed cabling can also provide one or more radiating channels for radiating the RF/cellular signal without the use of separate antennas. The adhesive-backed cabling structure allows for custom designed or programmable radiation areas from the adhesive-backed cabling at certain locations along the cabling, where RF signal level can be preserved in other portions of the cable. Thus, the adhesive-backed cabling enables flexible network design and optimization for a given indoor radiative environment.

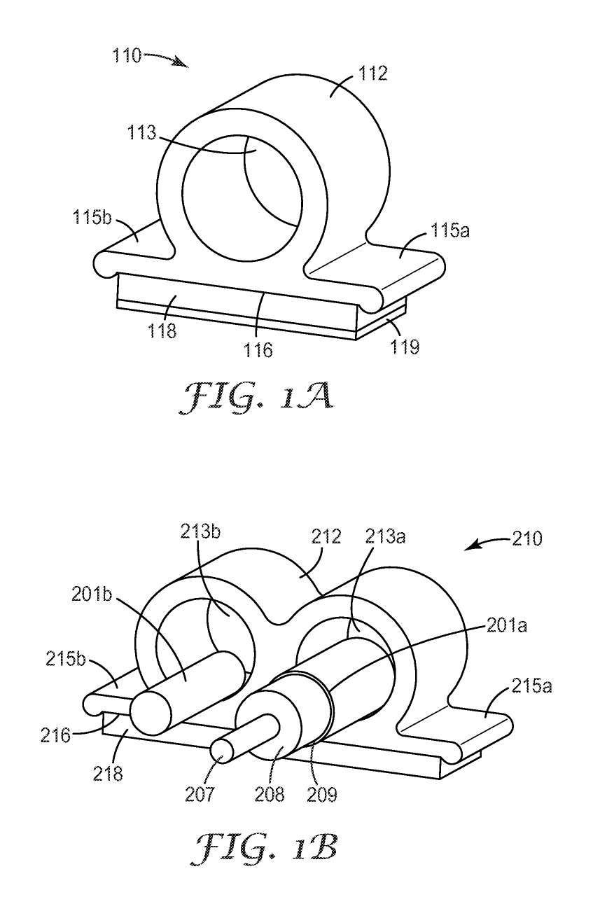

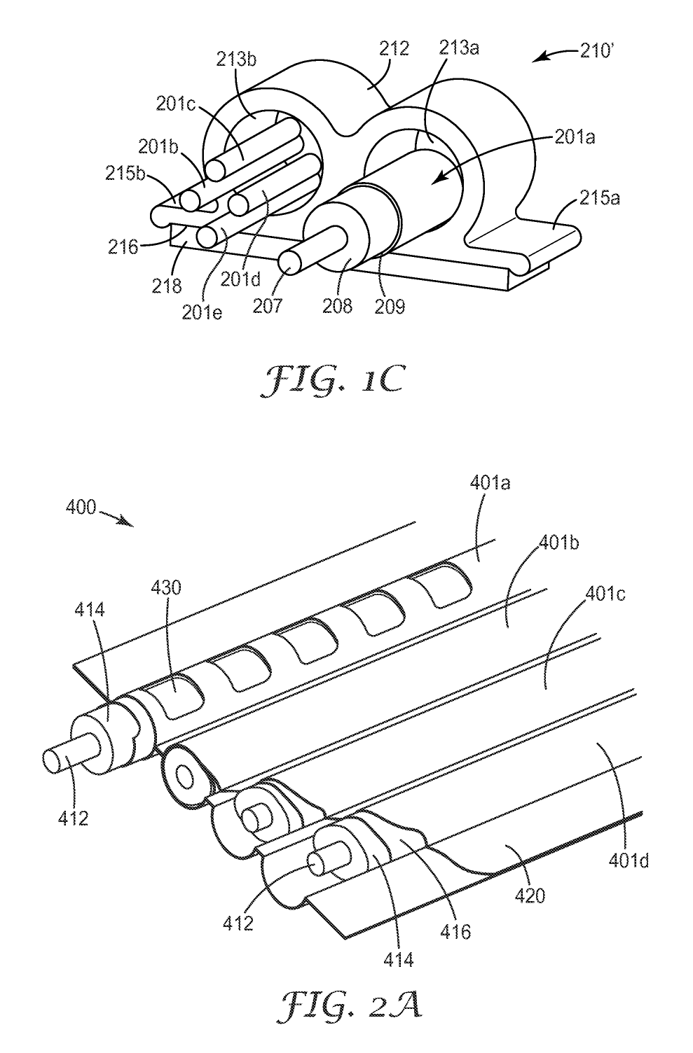

In a first aspect of the invention, an adhesive-backed cabling duct 110 accommodates one or more RF signal channels to provide horizontal cabling for IBW applications. As shown in FIG. 1A, duct 110 includes a main body 112 having a conduit portion with a bore 113 provided therethrough. The bore 113 is sized to accommodate one or more RF communication lines disposed therein. These RF communication lines, as explained further below, can include coax cables, optical fibers, and/or power lines. In use, the duct 110 can be pre-populated with one or more RF communication lines. In a preferred aspect, the RF communication lines are configured to transmit RF signals, having a transmission frequency range of from about 300 MHz to about 6 GHz.

While the conduit portion can have a generally circular cross-section, in alternative embodiments it may have another shape, such as a rectangular, square, triangular, oval, or other polygonal shaped cross-section.

In one aspect, duct 110 is a structure formed from a polymeric material, such as a polyolefin, a polyurethane, a polyvinyl chloride (PVC), or the like. For example, in one aspect, duct 110 can comprise an exemplary material such as a polyurethane elastomer, e.g., Elastollan 1185A10FHF. Additives, such as flame retardants, stabilizers, and fillers can also be incorporated as required for a particular application. In a preferred aspect, duct 110 is flexible, so that it can be guided and bent around corners and other structures without cracking or splitting. Duct 110 can be continuously formed using a conventional extrusion process.

In an alternative aspect, duct 110 can be formed from a metallic material, such as copper or aluminum. In one aspect, the metallic material may be pre-laminated with a polymer film, such as a liquid crystal polymer or thermoplastic material, having a relatively thin thickness (e.g., up to 2 mils), that forms an outer skin or shell around the main body of the duct. This outer skin can help prevent moisture from penetrating the duct and can also be used as a decorative cover.

Duct 110 also includes a flange or similar flattened portion to provide support for the duct 110 as it is installed on or mounted to a wall or other mounting surface, such as a floor, ceiling, or molding. In most applications, the mounting surface is generally flat. The mounting surface may have texture or other structures formed thereon. In other applications, the mounting surface may have curvature, such as found with a pillar or column. The flange extends along the longitudinal axis of the duct as shown in FIG. 1A. Exemplary duct 110 includes a double flange structure, with flange portions 115a and 115b, positioned (in use) below the centrally positioned conduit portion. In an alternative aspect, the flange can include a single flange portion. In alternative applications, a portion of the flange can be removed for in-plane and out-of-plane bending.

In a preferred aspect, the flange 115a, 115b includes a rear or bottom surface 116 that has a generally flat surface shape. This flat surface provides a suitable surface area for adhering the duct 110 to a mounting surface, a wall or other surface (e.g., dry wall or other conventional building material) using an adhesive layer 118.

Optionally, duct 110 can include a strength member, such as an aramid string or thread (e.g., a woven or non-woven Kevlar material) that is twisted or aramid yarn. The aramid string or aramid yarn can be bonded or un-bonded. Alternative strength member materials include metallic wire or a fiberglass member. The strength member can run lengthwise with the main body of duct 110 and can be disposed between the bottom surface 116 (of the duct's main body and/or flange 115a/115b) and adhesive layer 118. The strength member can help prevent elongation and relaxation of the duct during and after installation, where such elongation and relaxation may cause disbondment of the duct from the mounting surface.

In a preferred aspect of the present invention, the adhesive layer 118 comprises an adhesive, such as an epoxy, transfer adhesive, acrylic adhesive or double-sided tape, disposed on all or at least part of surface 116. In one aspect, adhesive layer 118 comprises a factory applied 3M VHB 4941F adhesive tape (available from 3M Company, St. Paul Minn.). In another aspect, adhesive layer 118 comprises a removable adhesive, such as a stretch release adhesive. By “removable adhesive” it is meant that the duct 110 can be mounted to a mounting surface (preferably, a generally flat surface, although some surface texture and/or curvature are contemplated) so that the duct 110 remains in its mounted state until acted upon by an installer/user to remove the duct from its mounted position. Even though the duct is removable, the adhesive is suitable for those applications where the user intends for the duct to remain in place for an extended period of time. Suitable removable adhesives are described in more detail in PCT Patent Application No. US2011/029715, incorporated by reference herein in its entirety.

In an alternative aspect, adhesive backing layer 118 includes a removable liner 119. In use, the liner 119 can be removed and the adhesive layer can be applied to a mounting surface.

While many of the ducts described herein are shown having a symmetrical shape, the duct designs can be modified to have an asymmetric shape (such as a flange wider on one side than the other), as would be apparent to one of ordinary skill in the art given the present description.

Moreover, the ducts described herein may be coextruded with at least two materials. A first material can exhibit properties that afford protection of the communication lines or other cables within the conduit portion of each duct such as against accidental damage due to impact, compression, or even provide some protection against intentional misuse such as stapling. A second material can provide functional flexibility for cornering.

In some aspects, the ducts can include a V0 flame retardant material, can be formed from a material that is paintable, or in a further alternative, covered with another decorative material.

In another aspect, as shown in FIG. 1B, an adhesive-backed duct 210 accommodates multiple RF signal channels to provide horizontal cabling for IBW applications. Duct 210 includes a main body 212 having multiple conduits, here bores 213a and 213b, provided therethrough. The bores 213a and 213b are each sized to accommodate one or more RF communication lines disposed therein. In this example, bore 213a is sized to accommodate a first RF signal channel 201a and bore 213b is sized to accommodate a second RF signal channel 201b. In this aspect, first RF signal channel 201a comprises a coax cable, having a conducting core 207 surrounded by a dielectric material 208 that is surrounded by an outer conductor shield 209. Second RF signal channel 201b comprises an optical fiber. The optical fiber signal channel can be optimized for carrying RFoG. For example, the optical fiber can comprise a single mode optical fiber designed to transport native RF signals. Multi-mode fibers can also be utilized in some applications. In an alternative aspect, as explained in further detail below, first RF signal channel 201a can comprise a radiating coax cable. In a further alternative aspect, bore 213b can accommodate at least a second coax cable or a power line. In another alternative aspect, the adhesive-backed cabling can further include one of more communication channels configured as CAT5, CAT6 lines. In another alternative, power can be transmitted over the conducting core of one or more of the coax lines.

Duct 210 can be a structure formed from a polymeric material, such as those described above. In a further aspect, the duct 210 can be directly extruded over the communications lines in an over jacket extrusion process. Alternatively, duct 210 can be formed from a metallic material, such as copper or aluminum, as described above. Duct 210 can be provided to the installer with or without an access slit.

Duct 210 also includes a flange 215a, 215b or similar flattened portion to provide support for the duct 210 as it is installed on or mounted to a wall or other mounting surface, such as a floor, ceiling, or molding. In a preferred aspect, the flange 215a, 215b includes a rear or bottom surface 216 that has a generally flat surface shape. Optionally, duct 210 can include one or more strength members, such as those described above. In a preferred aspect, an adhesive layer 218 comprises an adhesive, such as an epoxy, transfer adhesive, acrylic adhesive, pressure sensitive adhesive, double-sided tape, or removable adhesive, such as those described above, disposed on all or at least part of surface 216. Although not shown, a removable liner can be provided and can be removed when the adhesive layer is applied to a mounting surface.

In another aspect, as shown in FIG. 1C, an adhesive-backed duct 210′ accommodates multiple RF signal channels to provide horizontal cabling for IBW applications. Duct 210′ includes a main body 212 having multiple conduits, here bores 213a and 213b, provided therethrough. The bores 213a and 213b are each sized to accommodate one or more RF communication lines disposed therein. In this example, bore 213a is sized to accommodate a first RF signal channel 201a, configured as a coax cable or, more specifically, a radiating coax cable, and bore 213b is sized to accommodate multiple RF signal channels 201b, 201c, 201d, and 201e, each configured as an optical fiber. A greater or fewer number of RF signal channels can be disposed in bore 213b in alternative aspects.

In this aspect, each of channels 201b-201e can be configured as a separate RF signal pathway. Thus, channel 201b can provide a signal pathway at a first frequency band, channel 201c can provide a signal pathway at a second frequency band, channel 201d can provide a signal pathway at a third frequency band, and channel 201e can provide a signal pathway at a fourth frequency band. Alternatively, channel 201b can provide a signal pathway for a first service provider, channel 201c can provide a signal pathway for a second service provider, channel 201d can provide a signal pathway for a third service provider, and channel 201e can provide a signal pathway for a fourth service provider. Alternatively, channel 201b can provide a signal pathway for a first type of service (e.g., GSM), channel 201c can provide a signal pathway for a second type of service (e.g., iDEN), channel 201d can provide a signal pathway for a third type of service (e.g., UMTS), and channel 201e can provide a signal pathway for a fourth type of service (e.g., PCS/cellular).

In an alternative aspect, duct 210′ can accommodate at least a second coax cable or a power line. For example, although not shown, bore 213a can include a first coax cable and bore 213b can include a second coax cable.

Duct 210′ can be a structure formed from a polymeric material or a metallic material, such as those described above. Duct 210′ can be provided to the installer with or without a slit. In a further aspect, the duct 210′ can be directly extruded over the communications lines in an over jacket extrusion process.

Duct 210′ also includes a flange or similar flattened portion to provide support for the duct 210′ as it is installed on or mounted to a wall or other mounting surface, such as a floor, ceiling, or molding. In a preferred aspect, the flange 215a, 215b includes a rear or bottom surface 216 that has a generally flat surface shape. Optionally, duct 210′ can include one or more strength members, such as those described above. In a preferred aspect, an adhesive layer 218 comprises an adhesive, such as an epoxy, transfer adhesive double-sided tape, or removable adhesive, such as those described above, disposed on all or at least part of surface 216. Although not shown, a removable liner can be provided and can be removed when the adhesive layer is applied to a mounting surface.

In a further alternative aspect, the duct 210, 210′ can include multiple conduits, each having a bore of a different size, where each bore can be configured to house a specific cable type within the bore.

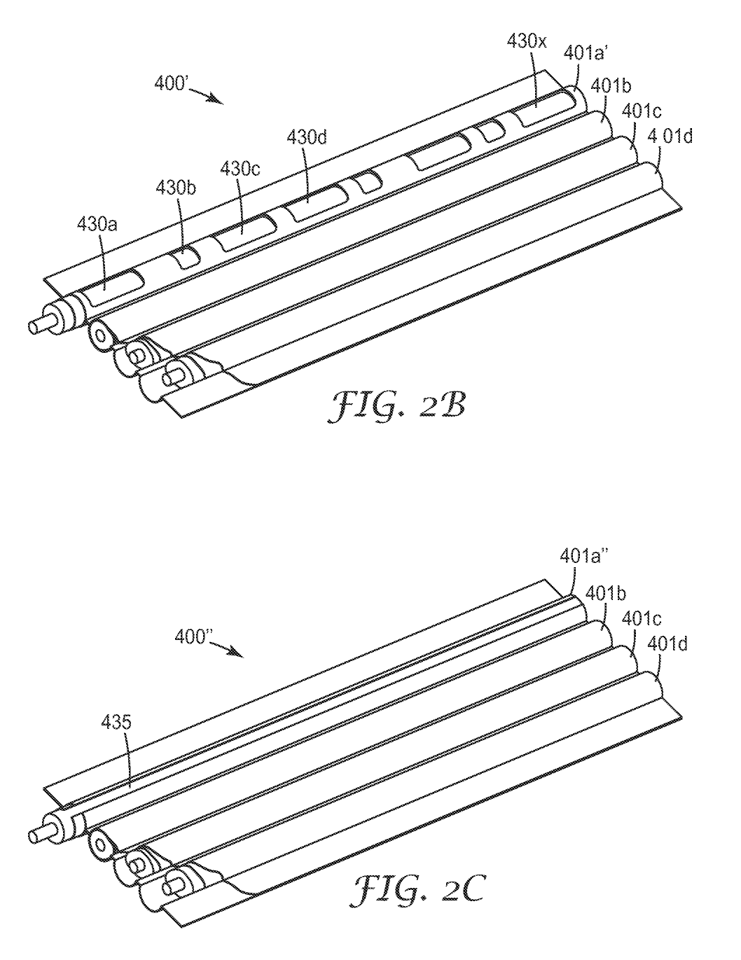

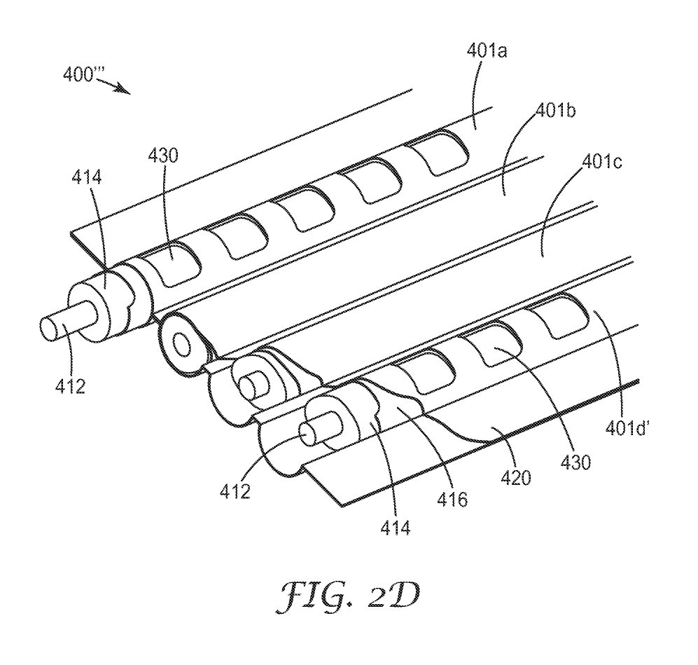

In another embodiment, the adhesive-backed cabling duct is configured as a laminated multi-channel (LMC) cable that can be utilized to provide multi-channel RF signal distribution. As shown in FIG. 2A, LMC cable 400 includes multiple channels 401a-401d, each including a communication line. Of course, as will be apparent to one of ordinary skill in the art given the present description, LMC cable 400 can include a fewer or greater number of communication line channels (e.g., two channels, three channels, five channels, six channels, etc.).

In one aspect, each of the channels comprises a coaxial cable, having a center conductor 412 surrounded by a dielectric material 414 that is surrounded by an outer conductor shield 416. The center conductor 412 can be a conventional metal wire such as copper. In some applications, such as for microwave coax applications, the center conductor 412 can comprise an aluminum wire with copper plating. The dielectric material 414 can be a conventional dielectric material such as a foam dielectric that entrains a substantial amount of air to provide a low loss dielectric. The outer conductor shield 416 is a conventional metal (foil) or metal foil in combination with a vacuum deposited metal on the dielectric material. Such a waveguide structure can provide low skin effect losses and good RF ground. In a preferred aspect, coax cable channels are configured to provide for transmission of radio frequency (RF) signals, having a transmission frequency range of from about 300 MHz to about 6 GHz.

A metallic secondary outer sheath 420 can be laminated over each of the channels 401a-401d to provide a single cable assembly structure. In this example, the metallic secondary outer sheath 420 is laminated directly over conductor shields 416 for each of the channels 401a-401d. The metallic secondary outer sheath 420 can be formed from a metal, such as copper or aluminum, having a thickness of about 0.001″ to about 0.015″.

Outer sheath 420 can be laminated onto the signal channels 401a-401d using a conventional lamination process, such as a roll-to-roll process, where two outer sheath layers 420 are bonded onto the signal channels 401a-401d. Bonding can be accomplished using a thermoplastic liner, a hot-melt adhesive in selective locations, or another conventional process. In one aspect, a lamination process such as is described in U.S. Pat. Appl. No. 61/218,739, incorporated by reference herein in its entirety, can be utilized.

The metallic outer sheath 420 is fire retardant and can provide heat dissipation. Moreover, the outer sheath 420 can provide a common RF ground for the multiple channels disposed therein. The metallic outer sheath 420 also provides for mechanical stability during installation. Although this exemplary embodiment describes a lamination process as forming LMC cable 400, cable 400 can also be constructed using alternative processes, such as resistance welding the top and bottom outer metallic layers between the signal channels and/or along the periphery.

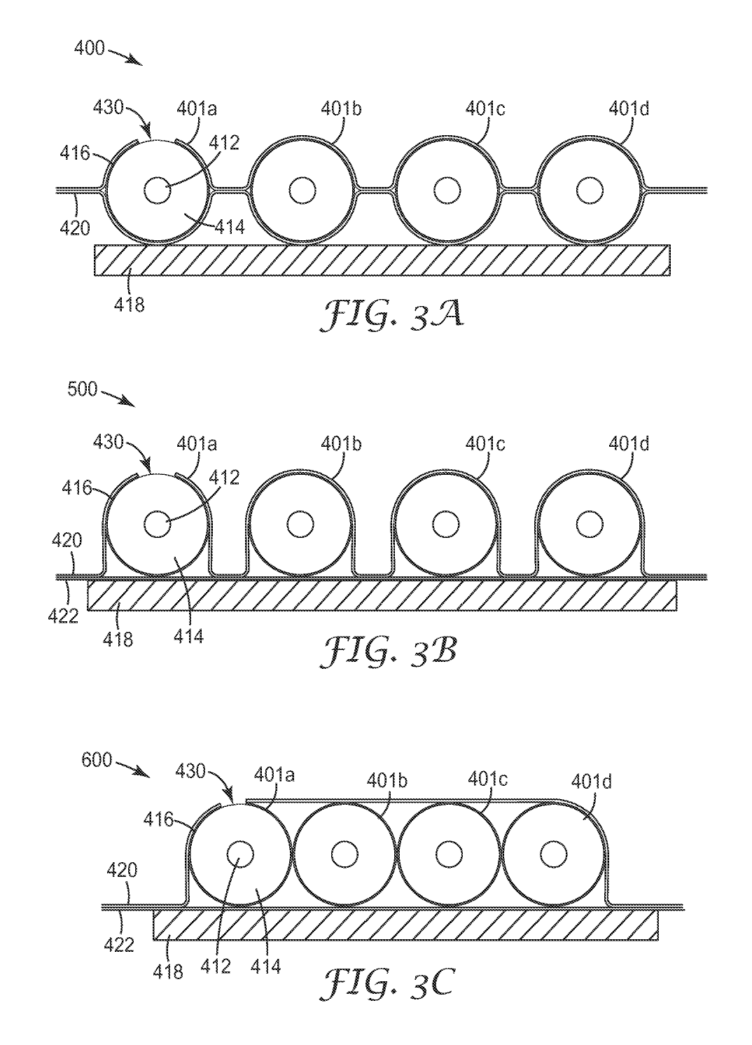

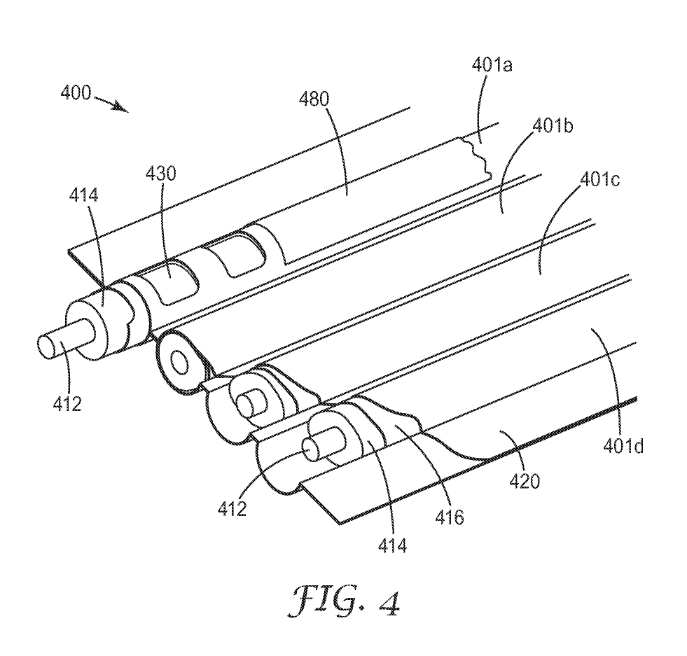

Cable 400 can have a low profile, generally flat construction and can be used for a variety of IBW horizontal cabling applications. For example, as shown in cross section view in FIG. 3A, outer sheath 420 is laminated onto each of the coax channels 401a-401d such that the conductor shields 416 for each channel are not in direct contact. In addition, an adhesive backing layer 418 is provided on one side of cable 400 to help mount LMC cable 100 to a standard mounting surface, such as those described above. The adhesive backing layer 418 comprises an adhesive, such as an acrylic, pressure sensitive adhesive, or one of the other adhesives described above.

In another alternative aspect, as shown in cross section view in FIG. 3B, an alternative LMC cable 500 is shown, where the top layer of outer sheath 420 is laminated over each of the coax channels 401a-401d and the lower sheath layer provides a flat rear surface 422. An adhesive backing layer 418 can also be provided on at least a portion of surface 422. In a further alternative, as shown in cross section view in FIG. 3C, an alternative LMC cable 600 is shown, where the outer sheath 420 is laminated onto each of the coax channels 401a-401d, which are compressed together such that each channel is touching a neighboring channel and such that the LMC cable 600 also has a flat rear surface 422. An adhesive backing layer 418 can also be provided on at least a portion of surface 422. In a further alternative aspect, for LMC cables 500 and 600, each channel 401a-401d can be formed without a conductor shield 416.

Optionally, LMC cable 400, 500, 600 can further include a very thin (e.g., up to 2 mils thickness) outer skin formed from a low dielectric material to cover the outer perimeter of the cable. This low dielectric material outer skin can prevent moisture from penetrating the foamed dielectric in each coax channel where radiating apertures have been made in the outer shield/conductor sheath. The low dielectric material outer skin can also be used as a decorative cover. Alternatively, in areas in which radiating structures are created with apertures in the outer metallic shield, an exemplary sealing material comprises a Novec fluid, such as EGC-1700 or EGC-2702, which provides a hydrophobic coating to seal radiating apertures.

Referring back to FIG. 2A, in one aspect, first channel 401a is a dedicated radiating channel which radiates a cellular communications signal via an arrangement of one or more radiating apertures 430 that are cut through the secondary outer sheath 420 and the outer conductor shield 416 over first channel 401a. The slots can comprise a repeating periodic structure of apertures 430 formed to have a specific axial length and transverse width and axially spaced down the length of first channel 401a. When such apertures have a regular spacing and size, the impedance mismatch between open areas and covered areas can produce a tuning effect. In an alternative aspect, as provided in more detail below, apertures 430 can be provided in a non-periodic, or even random, configuration along the length of the first channel 401a. In one aspect, channel 401a can operate as a radiating (send) and receive channel. In other aspects, first channel 401a operates as a send channel only. In other aspects, first channel 401a operates as a receive channel only.

Unlike traditional leaky coax, first channel 401a can be custom designed so that radiating portions of the first channel are limited to selected areas. For example, the incorporation of metallic tape over some of the radiating apertures 430 allows for preserving the signal level between the head end and the place where the signal is to be radiated. As shown in FIG. 4, metallic tape 480 can be placed over a portion of first channel 401a. Metallic tape 480 can be a copper foil with a very thin layer of adhesive (for maximizing the capacitive coupling to the outer metallic layer) and optionally a decorative outer layer for aesthetic purposes, typically matching the appearance of the outer metallic layer. The installer can route cable 400 through a building and remove the factory laminated removable foil tape in areas where RF transmission into the room or area is desired. The incorporation of metallic tape allows for in-field programmable radiation location to be established, as needed for the particular installation. In addition, the selective use of the metallic tape allows for the use of smaller coax, with easier installation but higher intrinsic loss, as the radiation loss is reduced in areas where radiated signal is not needed.

In an example manufacturing process, the LMC cable 400, 500, 600 may enter an in-line punch station to punch radiating apertures in a given coax channel. This process may be under computer control to allow for the custom manufacture of cables per given network design. The punched conductor shield/sheath can then be laminated into the cable structure. A copper or aluminum adhesive strip may be placed over the apertures creating a shield that may later be removed to provide in-field programmable radiation pattern.

Referring back to FIG. 2A, cable 400 further includes channels 401b-401d, each comprise a coax construction. In this aspect, each of channels 401b-401d is configured as a separate RF signal pathway. Thus, channel 401b can provide a signal pathway at a first frequency band, channel 401c can provide a signal pathway at a second frequency band, etc. Alternatively, channel 401b can provide a signal pathway for a first service provider, channel 401c can provide a signal pathway for a second service provider, etc. Alternatively, channel 401b can provide a signal pathway for a first type of service (e.g., GSM), channel 401c can provide a signal pathway for a second type of service (e.g., iDEN), etc.

One benefit of this type of cable configuration is that by having separated service pathways, the effects of passive inter-modulation (PIM, where services operating at different frequencies interact) can be reduced.

As mentioned above, the adhesive-backed cabling of the present invention can include an RF signal channel having a radiating coax construction. For example, FIG. 2A shows first channel 401a as having radiating apertures 430 spaced at regular intervals. As mentioned above, when the apertures have a regular spacing and size, the impedance mismatch between open areas and foil covered areas can produce a tuning effect. This effect induces some frequency selective tuning, which can be undesirable. In some aspects, the cable configuration can allow for purposeful tuning to be introduced to filter out an unwanted frequency.

The adhesive-backed cable configuration further provides for ways for reducing or eliminating the tuning effects to provide for broad band performance. In one alternative aspect, radiating apertures are formed via a “random” punching geometry. During formation, the cable can be passed through a computer controlled in-line punch, in which a pre-selected random sequence (within specified minimum and maximum spacing) is used to drive the computer controlled punch. For example, FIG. 2B shows an alternative cable 400′ having a first channel 401a′ with a set of radiating apertures 430a-430x randomly spaced along the axial length of the channel. Each of the apertures 430a, 430b, 430c, 430d, etc. can have a different shape (length and width) and each of the apertures can be separated by a different distance along the axial length of the channel 401a′. An adhesive backing layer (not shown), such as those described above, can be provided on cable 400′ for mounting to a general mounting surface.

In another alternative aspect, broadband performance can be obtained by including a longitudinal slot in the outer sheath 420. For example, as shown in FIG. 2C, an alternative cable 400″ includes a first channel 401a″ having a slot 435 formed lengthwise in the outer sheath/conductor shield. Slot 435 has about a 20 degree to about a 55 degree opening, preferably about a 45 degree opening, along the entire axial length of channel 401a″, or at least a substantial portion of the axial length of channel 401a″. This configuration changes the impedance of the transmission line (in one example, using a 45 degree slot in a channel having a construction similar to a conventional Times Microwave (Amphenol) LMR-400 coax cable, the impedance increases from 50 to 50.6 ohms). The tradeoff to be considered with this elongated slot 435 is the decrease in mechanical strength. For this alternative embodiment, an outer coating or encasing material, such as the low dielectric material mentioned previously, can be used to gain additional mechanical strength. Alternatively, a low-dielectric film or tape covering over the slot may be utilized, for example. An adhesive backing layer (not shown), such as those described above, can be provided on cable 400″ for mounting to a general mounting surface.

In another aspect, the adhesive-backed cable of the present invention can include multiple radiating channels. For example, as shown in FIG. 2D, LMC cable 400′″ includes radiating channels 401a and 401d′, each having a plurality of radiating apertures 430 formed thereon. The radiating channels 401a and 401d may utilize periodic spaced apertures or randomly spaced apertures. In this configuration, the radiating channels are separated by signal channels 401b and 401c. With this configuration, the separated radiating channels are less likely to induce crosstalk. Alternatively, radiating channels can be adjacent one another—for example, channels 401a and 401b can be radiating channels, or channels 401b and 401c can be radiating channels. In a further alternative, a plurality of radiating channels can each be separated by a non-radiating channel—for example channel 401a and channel 401c can be radiating channels, separated by a non-radiating channel 401b.

In a further alternative, each channel 401a-401d can be constructed such that each outer conductor shield has a longitudinal slotted construction, for example from about a 20 degree to about a 55 degree opening, preferably about a 45 degree opening slot longitudinally formed over channel. The cable can be laminated with a metallic outer sheath to cover the channels where needed for a particular application.

In addition, the radiating channels can each have a different aperture structure, such as the random aperture structure shown in FIG. 2B or the longitudinal slotted structure shown in FIG. 2C.

The above described adhesive-backed cable configurations can be utilized in a variety of IBW applications with a variety of different IBW architectures. For example, the LMC cabling described herein can be used as part of a passive copper coax distribution architecture. In this architecture, the multiple signal channels can each comprise a coax cable construction. With only a head-end active component, the one or more radiating channels in the adhesive-backed cable obviate the need to implement multiple antennas throughout the building. For example, for installation below a drop ceiling, the generally planar structure of the cable allows radiating apertures to face downward as the cable lays flat against the drop ceiling support structure.

This system can also be implemented with discrete radiating antennas connected to the horizontal coax channels with conventional splitters, taps, and/or couplers. In this manner, multiple service carriers can utilize the adhesive-backed RF signal cabling as horizontal cabling or as part of a radiating antenna system, or both. This type of architecture can work with many different RF protocols (e.g., any cellular service, iDEN, Ev-DO, GSM, UMTS, CDMA, and others).

In one alternative aspect, the multi-channel cabling can include multiple coax cables. For example, separate coax conductors can connect to separate antennas of a multiple-input and multiple-output (MIMO) antenna system, e.g., a 2×2 MIMO antenna system, a 4×4 MIMO antenna system, etc. In another alternative aspect, first and second coax conductors can be coupled to a single antenna of a cross-polarization antenna system.

In another example, the adhesive-backed RF signal cabling described herein can be used as part of an active analog distribution architecture. In this type of architecture, RF signal distribution can be made over coax or fiber (RoF). In this architecture, the cabling can be combined with selected active components, where the types of active components (e.g., O/E converters for RoF, MMIC amplifiers) are selected based on the specific architecture type. This type of architecture can provide for longer propagation distances within the building and can work with many different RF protocols (e.g., any cellular service, iDEN, Ev-DO, GSM, UMTS, CDMA, and others).

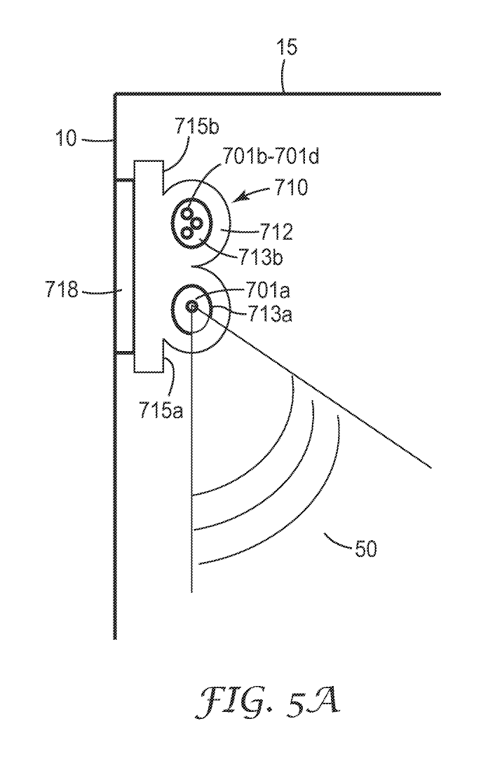

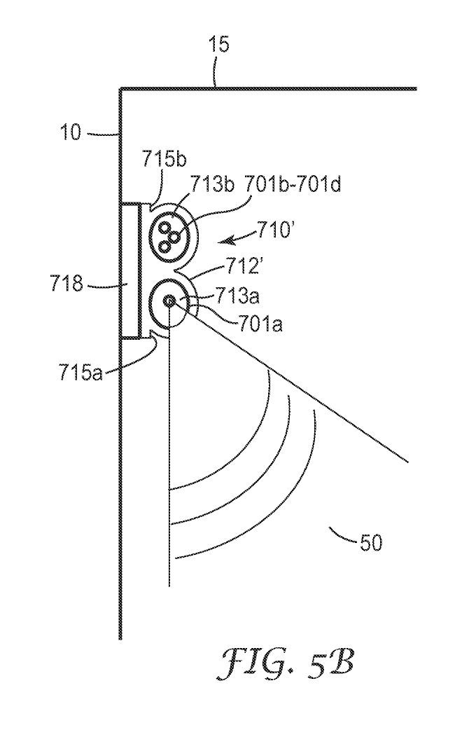

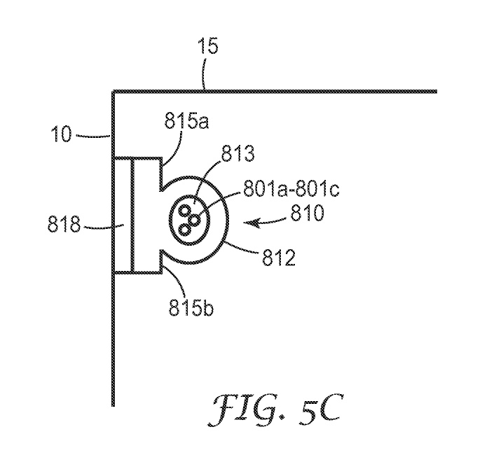

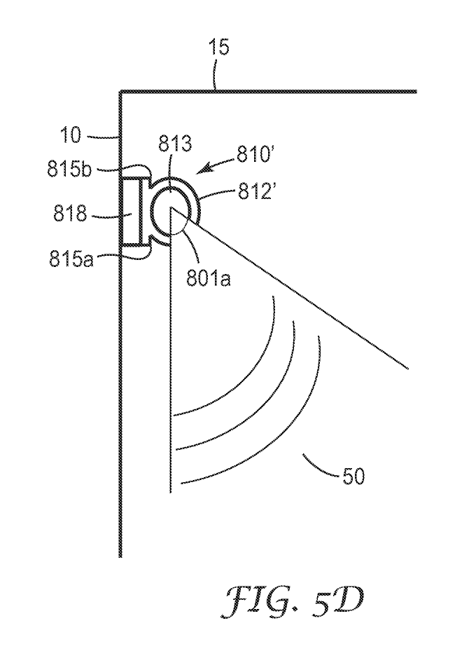

In one example implementation, as shown in FIG. 5A, an adhesive-backed cabling duct 710 can be formed having a dual conduit structure and can provide a hybrid cabling solution.

Duct 710 includes a main body 712 having multiple conduits, here bores 713a and 713b, provided therethrough. Bore 713a is sized to accommodate a first RF signal channel 701a, which comprises a radiating coax cable. In this aspect, bore 713a has an inner diameter that matches the outer diameter of the coax cable, thereby providing a snug fit which fixes the radial orientation of signal channel 701a during and after installation. Bore 713b is sized to accommodate RF signal channels 701b, 701c, and 701d. In this aspect, RF signal channels 701b-701d each comprises an optical fiber optimized for carrying RoF.

In this aspect, RF signal channel 710a comprises a radiating coax cable having a longitudinal slot similar to the construction of signal channel 401a″ shown in FIG. 2C, where a slot is formed lengthwise in the outer sheath/conductor shield, having about a 45 degree opening, along a substantial portion of the axial length of channel 401a″.

In this aspect, duct 710 is formed from a polymeric material, such as those described above, and can be directly extruded over the RF signal channels in an over-jacket extrusion process. Duct 710 also includes a flange structure 715a, 715b to provide support for the duct as it is mounted to wall 10 via an adhesive backing 718. Optionally, duct 710 can include one or more strength members, such as those described above. In a preferred aspect, an adhesive layer 718 comprises an adhesive, such as an epoxy, transfer adhesive double-sided tape, or removable adhesive, such as those described above.

In this aspect, duct 710 is mounted on wall 10 at a position just below ceiling 15. As the signal channel 701a is secured in its radial orientation along the length of the duct, duct 710 faces toward the center of the room or hallway, providing a radiating field 50 that can operate as an antenna to provide suitable coverage in the room, hallway, or other location to couple forward link and/or reverse link signals. In addition, RF signal channels 701b-701d provide multiple, separate RF pathways that can be dedicated to different carriers, different frequencies, and/or different services within a building.

Although duct 710 is shown being installed on wall 10 at a position just below the ceiling, duct 710 (or any of the adhesive-backed cables described herein) can also be installed at other heights on wall 10, on ceiling 15, on the floor of the room or hallway, or on other mounting structures, as would be apparent to one of ordinary skill in the art given the present description.

The example implementation shown in FIG. 5A can be useful, for example, in hybrid network architectures.

In another aspect, as shown in FIG. 5B, an adhesive-backed cabling duct 710′ can be formed similar to the dual conduit duct shown in FIG. 5A, but with a metallic body, to provide a hybrid cabling solution. Duct 710′ includes a main body 712′ having multiple conduits, here bores 713a and 713b. Bore 713a is sized to accommodate a first RF signal channel 701a, which comprises a radiating coax cable. In this aspect, bore 713a has an inner diameter that matches the outer diameter of the coax cable, thereby providing a snug fit which fixes the radial orientation of signal channel 701a along the length of the duct during and after installation. Bore 713b is sized to accommodate RF signal channels 701b, 701c, and 701d. In this aspect, RF signal channels 701b-701d each comprise an optical fiber optimized for carrying RoF.

In this aspect, RF signal channel 710a comprises a radiating coax cable having a longitudinal slot similar to the construction of signal channel 401a″ shown in FIG. 2C, where a slot is formed lengthwise in the outer sheath 420 and conductor shield 416, having about a 45 degree opening, along a substantial portion of the axial length of channel 401a″. Alternatively, RF signal channel 701a can comprises a radiating coax cable having an arrangement of randomly punched apertures formed along the length of the signal channel.

In this aspect, duct 710′ is formed from a metallic material, such as copper, and includes a thin polymer laminate (not shown) as an outer skin. Duct 710′ also includes a flange structure 715a, 715b to provide support for the duct as it is mounted to wall 10 via an adhesive backing 718. In a preferred aspect, adhesive layer 718 comprises an adhesive, such as an epoxy, transfer adhesive double-sided tape, or removable adhesive, such as those described above.

Similar to the embodiment of FIG. 5A, duct 710′ is mounted on wall 10 at a position just below ceiling 15. The signal channel 701a is secured in its radial orientation within bore 713a such that duct 710′ provides a radiating field 50 that can operate as an antenna to provide suitable coverage in a room, hallway, or other location to couple forward link and/or reverse link signals. In addition, duct 710′ includes RF signal channels 701b-701d to provide multiple, separate RF pathways.

The example implementation shown in FIG. 5B can be useful for hybrid network architectures.

In another aspect, as shown in FIG. 5C, an adhesive-backed cabling duct 810 can be formed similar to the single conduit duct shown in FIG. 1A. Duct 810 includes a main body 812 having a bore 813 formed therethrough. Bore 813 is sized to accommodate RF signal channels 801a-801c, although a greater or fewer number of RF signal channels can be disposed in bore 813. In this aspect, RF signal channels 801a-801c each comprise an optical fiber optimized for carrying RFoG.

In this aspect, duct 810 is formed from a polymeric material, such as those described above, and can be directly extruded over the RF signal channels in an over-jacket extrusion process. Duct 810 also includes a flange structure 815a, 815b to provide support for the duct as it is mounted to wall 10 via an adhesive backing 818. Optionally, duct 810 can include one or more strength members, such as those described above. In a preferred aspect, an adhesive layer 818 comprises an adhesive, such as an epoxy, transfer adhesive double-sided tape, or removable adhesive, such as those described above. RF signal channels 801a-801c provide multiple, separate RF pathways that can be dedicated to different carriers, different frequencies, and/or different services within a building.

The example implementation shown in FIG. 5C can be useful for active DAS network architectures.

In another aspect, as shown in FIG. 5D, an adhesive-backed cabling duct 810′ can be formed similar to the single conduit duct shown in FIG. 5C. Duct 810′ includes a main body 812′ having a bore 813 formed therethrough. Bore 813 is sized to accommodate RF signal channel 801a, which can include a non-radiating coax or a radiating coax cable. As shown in FIG. 5D, a radiating coax cable is provided having a longitudinal slot similar to the construction of signal channel 401a″ shown in FIG. 2C, where a slot is formed lengthwise in the outer sheath 420 and conductor shield 416, having about a 45 degree opening, along a substantial portion of the axial length of channel 401a″. Alternatively, RF signal channel 801a can comprises a radiating coax cable having an arrangement of randomly punched apertures formed along the length of the signal channel.

In this aspect, duct 810′ is formed from a metallic material, such as copper, and includes a thin polymer laminate (not shown) as an outer skin. Duct 810′ also includes a flange structure 815a, 815b to provide support for the duct as it is mounted to wall 10 via an adhesive backing 818. In a preferred aspect, adhesive layer 818 comprises an adhesive, such as an epoxy, transfer adhesive double-sided tape, or removable adhesive, such as those described above.

Similar to the embodiment of FIG. 5A, duct 810′ is mounted on wall 10 at a position just below ceiling 15. The signal channel 801a is secured in its radial orientation within bore 813 such that duct 810′ provides a radiating field 50 that can operate as an antenna to provide suitable coverage in a room, hallway, or other location to couple forward link and/or reverse link signals.

The example implementation shown in FIG. 5D can be useful for passive or active DAS horizontal cabling (non-radiating or radiating) network architectures and for active DASs in lieu of discrete antennas.

Exemplary tooling that can be utilized to mount exemplary adhesive-backed cabling is described in US Pat. Publ. No. US2009-0324188.

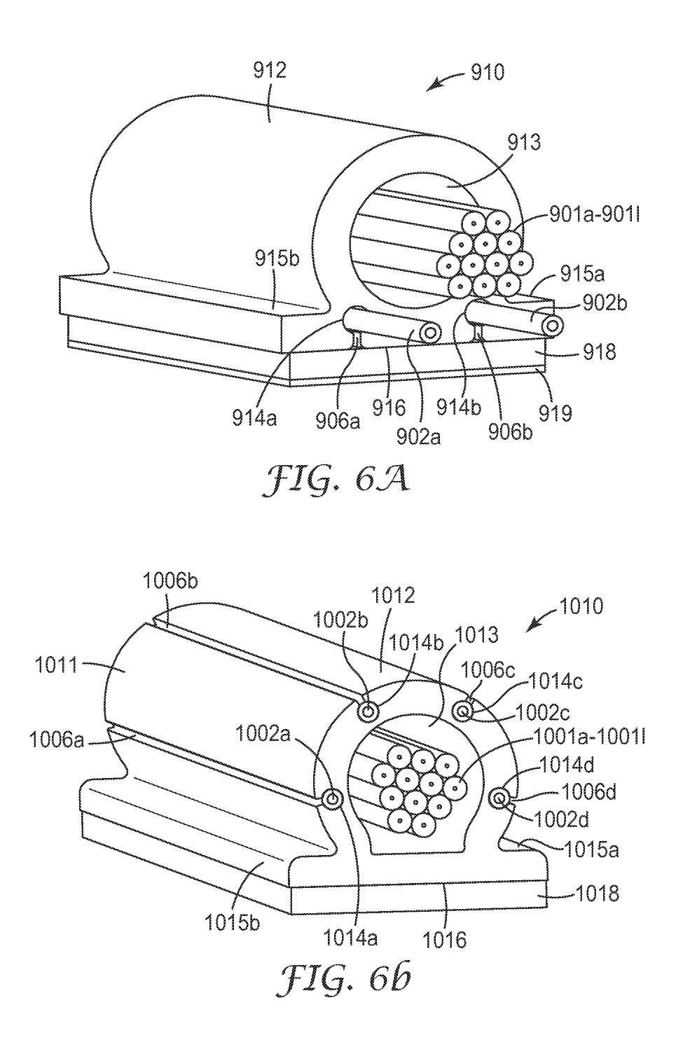

In another aspect, as shown in FIG. 6A, an adhesive-backed duct 910 accommodates multiple channels to provide horizontal cabling for IBW applications. Duct 910 includes a main body 912 having multiple conduits, here bore 913 and additional bores 914a and 914b formed in the flange structure of the duct, provided therethrough. In this aspect, the bore 913 is sized to accommodate one or more RF communication lines disposed therein. In this example, bore 913 is sized to accommodate twelve optical fibers 901a-901l. Of course, a greater or fewer number of optical fibers can be utilized, depending on the application. The optical fibers can be optimized for carrying RFoG. For example, the optical fibers can comprise single mode optical fibers designed to transport native RF signals. Multi-mode fibers can also be utilized in some applications.

The additional bores 914a and 914b can provide additional signal channels and/or power lines. In this aspect, first additional channel 914a carries a first power line 902a and second additional channel 914b carries a second power line 902b. Alternatively, first and second additional channels 914a, 914b can carry coaxial cables. Access to first and second additional channels 914a, 914b can be provided via slits 906a, 906b, respectively. In another alternative aspect, the adhesive-backed cabling can further include one of more communication channels configured as CAT5, CAT6 lines. In another alternative, power can be transmitted over the conducting core of one or more of the coax lines.

Duct 910 can be a structure formed from a polymeric material, such as those described above. In a further aspect, the duct 910 can be directly extruded over the communications lines in an over jacket extrusion process. Alternatively, duct 910 can be formed from a metallic material, such as copper or aluminum, as described above. Duct 910 can be provided to the installer with or without an access slit(s).

Duct 910 also includes a flange 915a, 915b or similar flattened portion to provide support for the duct 910 as it is installed on or mounted to a wall or other mounting surface, such as a floor, ceiling, or molding. In a preferred aspect, the flange 915a, 915b includes a rear or bottom surface 916 that has a generally flat surface shape. Optionally, duct 910 can include one or more strength members, such as those described above. In a preferred aspect, an adhesive layer 918 comprises an adhesive, such as an epoxy, transfer adhesive, acrylic adhesive, pressure sensitive adhesive, double-sided tape, or removable adhesive, such as those described above, disposed on all or at least part of surface 916. A removable liner 919 can be provided and can be removed when the adhesive layer is applied to a mounting surface.

In another aspect, as shown in FIG. 6B, an adhesive-backed duct 1010 accommodates multiple channels to provide horizontal cabling for IBW applications. Duct 1010 includes a main body 1012 having multiple conduits, here bore 1013 and four additional bores 1014a-1014d formed in the outer jacket 1011 structure of the duct, provided therethrough. Although four additional bores 1014a-1014d are shown in FIG. 6B, a greater or fewer number of additional bores can be provided. In this aspect, the bore 1013 is sized to accommodate one or more RF communication lines disposed therein. In this example, bore 1013 is sized to accommodate twelve optical fibers 1001a-1001l. Of course, a greater or fewer number of optical fibers can be utilized, depending on the application. The optical fibers can be optimized for carrying RFoG. For example, the optical fibers can comprise single mode optical fibers designed to transport native RF signals. Multi-mode fibers can also be utilized in some applications.

The additional bores 1014a-1014b can provide additional signal channels and/or power lines. In this aspect, first additional channel 1014a carries a first power line 1002a, second additional channel 1014b carries a second power line 1002b, third additional channel 1014c carries a third power line 1002c, and fourth additional channel 1014d carries a fourth power line 1002d. Alternatively, the additional channels 1014a-1014d can carry coaxial cables. Access to the additional channels 1014a-1014d can be provided via slits 1006a-1006d, respectively, which run along the length of the duct. This design allows the installer to insert or remove power lines from duct 1010 as needed in a straightforward manner. In another alternative aspect, the adhesive-backed cabling can further include one of more communication channels configured as CAT5, CAT6 lines. In another alternative, power can be transmitted over the conducting core of one or more of the coax lines.

Duct 1010 can be a structure formed from a polymeric material, such as those described above. In a further aspect, the duct 1010 can be directly extruded over the communications lines in an over jacket extrusion process. Alternatively, duct 1010 can be formed from a metallic material, such as copper or aluminum, as described above. Duct 1010 can be provided to the installer with or without an access slit(s).

Duct 1010 also includes a flange 1015a, 1015b or similar flattened portion to provide support for the duct 1010 as it is installed on or mounted to a wall or other mounting surface, such as a floor, ceiling, or molding. In a preferred aspect, the flange 1015a, 1015b includes a rear or bottom surface 1016 that has a generally flat surface shape. Optionally, duct 1010 can include one or more strength members, such as those described above. In a preferred aspect, an adhesive layer 1018 comprises an adhesive, such as an epoxy, transfer adhesive, acrylic adhesive, pressure sensitive adhesive, double-sided tape, or removable adhesive, such as those described above, disposed on all or at least part of surface 1016. Although not shown, a removable liner can be provided and can be removed when the adhesive layer is applied to a mounting surface.

The adhesive-backed cabling described herein can also be utilized in other indoor and outdoor applications, and in commercial or residential buildings, such as in office buildings, professional suites, and apartment buildings.

The adhesive-backed cabling described above can be used in buildings where there are a lack of established horizontal pathways from the intermediate distribution frames (IDFs) to an antenna as the cabling can provide radiating coax. In addition, for buildings with drywall ceilings and little or no access panels, the adhesive-backed cabling of the present invention can be installed without having to enter the existing drywall ceiling. Some older buildings may have missing or inaccurate blueprint, thus the adhesive-backed cabling described herein can be installed on the basis of a visual survey. The adhesive-backed cabling helps minimize or eliminate the need to disturb existing elaborate trim and hallway decorum. In addition, the need to establish major construction areas can be avoided.

As described above with respect to the various adhesive-backed RF signal cable embodiments, the cabling of the present invention provides an RF signal distribution medium within a building or other structure that includes multiple channels. Thus, different carriers each needing wireless distribution in a building can utilize the adhesive-backed RF signal cabling, where a common horizontal installation can support different carriers, providing cost savings and carrier autonomy. In addition, different services, such as GSM, UMTS, IDEN, Ev-DO, LTE, and others can be distributed by the adhesive-backed RF signal cabling. Moreover, with the adhesive-backed RF signal cabling configurations discussed above, PIM is reduced or eliminated as separated signal pathways carry the services operating at different frequencies. Further, the adhesive-backed RF signal cabling can be implemented in various MIMO architectures for multi-path RF environments, where multiple lanes of coax can be directed to the antenna system. In another alternative, the adhesive-backed RF signal cabling can be utilized in a cross-polarization antenna system, which can transmit and receive from a single integrated antenna unit. The adhesive-backed RF signal cabling can provide same-length pathways for phase, delay control.

The adhesive-backed RF signal cabling also provides for routing signals to different locations within a building, such as “lunch room,” “conference room,” “meeting room”, etc. The multiple channel designs also allows for a separate receive channel to be set up independent of the other channels, if needed. This type of configuration can provide for better signal conditioning for getting the user equipment (UE) signal back to the cell site.

The LMC cabling can include radiating coax channels that serve as an antenna structure that can be installed on a building wall or in the ceiling in a straightforward manner. The incorporation of metallic tape over selected radiating apertures allows for preserving the signal level between the head end and the area where the signal is to be radiated. The metallic tape further allows for in-field programmable radiation location to be established, as needed for the particular installation. Also, the incorporation of metallic tape over selected radiating apertures allows for relatively small sized coax to be utilized for the multiple signal channels. This smaller product form factor can be much easier to install. Losses can be managed by sending separate signals to areas that are further from the head end, leaving the apertures sealed, using a separate receive coax channel, radiating power only where needed, and using amplifiers on an as-needed basis.

Thus, the adhesive-backed RF signal cable described herein, with its multiple outbound channels, dedicated receive channel, and in-field programmable radiators, provides for flexible network design and optimization in a given indoor radiative environment.

While the above embodiments are described in relation to IBW applications, the adhesive-backed RF signal cabling of the present invention can also be utilized in outdoor wireless applications as well.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. An adhesive-backed multi-channel RF signal cable, comprising:
a main body having at least one conduit portion with a bore formed throughout and containing one or more RF signal channels; and
a flange portion having an adhesive backing layer to mount the cable to a mounting surface.

2. The adhesive-backed multi-channel RF signal cable of claim 1, wherein the main body and flange portion are formed from a polymer.

3. The adhesive-backed multi-channel RF signal cable of claim 2, wherein the polymer is a polymer that is extruded over the one or more RF signal channels.

4. The adhesive-backed multi-channel RF signal cable of claim 1, wherein the main body and flange portion are formed from a metal.

5. The adhesive-backed multi-channel RF signal cable of claim 4, wherein the metal is covered by a layer of low dielectric material having a thickness of 2 mils or less.

6. The adhesive-backed multi-channel RF signal cable of claim 1, wherein the main body includes two conduit portions, wherein a first conduit includes a first RF signal channel and a second conduit includes a second RF signal channel.

7. The adhesive-backed multi-channel RF signal cable of claim 6, wherein the first RF signal channel comprises a coax cable and wherein the second RF signal channel comprises an optical fiber.

8. The adhesive-backed multi-channel RF signal cable of claim 7, wherein the coax cable is configured to radiatively send and/or receive a first RF signal from the first channel.

9. The adhesive-backed multi-channel RF signal cable of claim 8, wherein the radial position of the first RF signal channel is maintained throughout the length of the RF signal cable.

10. The adhesive-backed multi-channel RF signal cable of claim 8, wherein the first channel comprises a plurality of radiating apertures formed longitudinally along the axial length of the first channel.

11. The adhesive-backed multi-channel RF signal cable of claim 8, wherein the first channel includes a longitudinal slot formed along the axial length of the first channel, wherein the longitudinal slot has an opening from about 20 degrees to about 55 degrees.

12. The adhesive-backed multi-channel RF signal cable of claim 7, wherein the second conduit includes multiple optical fibers each providing its own separate RF signal channel.

13. The adhesive-backed multi-channel RF signal cable of claim 6, wherein the first RF signal channel comprises a first coax cable coupled to a first antenna and wherein the second RF signal channel comprises a second coax cable coupled to a second antenna.

14. The adhesive-backed multi-channel RF signal cable of claim 1, wherein the duct includes a main body having a first conduit portion and at least one additional conduit portion formed throughout, wherein a first conduit includes a plurality of optical fibers and a second conduit includes a power line.

15. The adhesive-backed multi-channel RF signal cable of claim 14, wherein the at least one additional conduit portion is formed in the flange.

16. The adhesive-backed multi-channel RF signal cable of claim 14, wherein the at least one additional conduit portion is formed in an outer jacket portion of the main body.

17. A distributed antenna system for in-building wireless applications, comprising:
an adhesive-backed multi-channel RF signal cable that includes a main body having at least one conduit portion with a bore formed throughout and containing one or more RF signal channels and a flange portion having an adhesive backing layer to mount the cable to a mounting surface.

18. The distributed antenna system of claim 17, wherein the adhesive-backed multi-channel RF signal cable includes a first RF signal channel carrying an RF signal from a first wireless service provider and a second RF signal channel carrying an RF signal from a second wireless service provider.

19. The distributed antenna system of claim 17, wherein the adhesive-backed multi-channel RF signal cable provides horizontal cabling for at least one of a hybrid network architecture, a passive network architecture, and a MIMO antenna system.

20-22. (canceled)

23. The distributed antenna system of claim 17, wherein the adhesive-backed multi-channel RF signal cable is adhesively mountable to a building wall at a position just below a ceiling.
